(19) United States
(12) Patent Application Publication
(10) Pub. No.: US 2009/0183754 A1
(43) Pub. Date: Jul. 23, 2009

(54) CLEANING MODULE, DEVICE AND METHOD FOR CLEANING MACHINES FOR THE PRODUCTION OF LIQUID FOODS

(75) Inventors: Heinz Vetterli, Wangen (CH); Matteo Ioannone, Steinmaur (CH)

Correspondence Address: VOLPE AND KOENIG, P.C., UNITED PLAZA, SUITE 1600, 30 SOUTH 17TH STREET, PHILADELPHIA, PA, 19103, US

(73) Assignee: NIRO-PLAN AG, Aarburg (CH)

(21) Appl. No.: 12/352,043

(22) Filed: Jan. 12, 2009

(30) Foreign Application Priority Data
Jan. 10, 2008 (DE) 102008003733.8

(51) Int. Cl. B08B 9/00; B08B 3/08; B08B 9/027; A47J 31/00; A47J 31/44; B67D 5/62

(52) U.S. Cl. 134/18; 134/22.12; 222/145.1; 99/285; 99/300; 222/146.6

(57) ABSTRACT

A cleaning module for machines for the production of liquid foods, particularly for coffee makers, including at least one reservoir for cleaning agents to accept cleaning agents, with at least one dosing device having a control connector and at least one discharge chamber, with the dosing device being connected to the cleaning reservoir and the discharge chamber such that cleaning agents can be fed by the dosing device from the reservoir for cleaning agents to the discharge chamber. The invention further relates to a device for the production of liquid foods and a method for its cleaning.

### CROSS-REFERENCE TO RELATED APPLICATIONS

This application claims the benefit of DE 10 2008 003 733.8, filed Jan. 10, 2008, which is incorporated herein by reference as if fully set forth.

### BACKGROUND

The invention relates to a cleaning module for machines for the production of liquid foods, particularly coffee makers. The invention further relates to a device for the production of liquid foods, particularly coffee, and a method for cleaning such a device.

Devices for the production of liquid foods typically comprise a feeding pump and a supply line so that liquid foods or a food additive can be transported by the feeding pump via the supply line from a reservoir into the device, and can here be further processed or mixed with another liquid food. It is known particularly in coffee makers to supply milk, syrup, or another additive from a reservoir into the coffee maker, and to discharge them at an outlet simultaneously or successively to the coffee.

Such devices must be regularly cleaned in order to ensure hygiene standards and to prevent deposits. Particularly when such devices are used in large facilities regular, usually daily cleaning is required according to predetermined stipulations.

Typically the above-described reservoir is removed for cleaning and replaced by a reservoir with cleaning agents. After a cleaning program has been started the feeding pump feeds the cleaning agent via the supply line into the machine and cleans the predetermined components of the machine. Subsequently the user has to exchange the reservoir with the cleaning agent for a reservoir with fresh water so that the device can be rinsed in another step of the cleaning program to prevent any retention of remnants of the cleaning agent in the machine.

The above-described cleaning process is expensive, because it requires the execution of intermediate processing steps by an operator. Furthermore, there are some potential causes for errors, for example filling the reservoir with the wrong cleaning agent, so that there is the risk for improper cleaning.

### SUMMARY

The invention is therefore based on the objective of improving the cleaning process for devices for the production of liquid foods, particularly to render it less expensive for the user, and to reduce the chances for errors.

This objective is attained in a cleaning module for machines for the production of liquid foods, particularly coffee makers, according to the invention, in a device for the production of liquid foods, particularly coffee according to the invention, as well as by a method for cleaning a device for the production of liquid foods, particularly coffee, according to the invention.

Advantageous embodiments of the cleaning module, advantageous embodiments of the device for the production of liquid foods, and advantageous embodiments of the method are described in detail below.

The invention therefore relates, on the one hand, to a cleaning module for machines for the production of liquid foods, particularly coffee makers.

As described at the outset, it has been known to connect a reservoir with a cleaning agent, for example via a supply line, to a device for the production of liquid foods so that the cleaning agent is supplied from the reservoir to clean the machine.

However, the cleaning module according to the invention comprises at least one reservoir for cleaning agents to accept cleaning agents, at least one dosing device with a control connection, and at least one discharge chamber. The dosing device is connected to the cleaning reservoir and the discharge chamber such that cleaning agents can be fed by the dosing device from the reservoir for cleaning agents to the discharge chamber.

Prior to the cleaning process the cleaning module according to the invention can therefore be placed by the user in its entirety next to or into the device for the production of liquid foods. Subsequently a fully automated cleaning program of the device runs, in which the dosing device of the cleaning module receives control signals via the control connection from the device for the production of liquid foods and, depending on said control signals, supplies cleaning agents into the discharge chamber. The discharge chamber is designed such that it can be connected to the fluid circuit of the device for the production of liquid foods.

Advantageously the reservoir of cleaning agents, the dosing device, and the discharge chamber form a structural unit.

This way, prior to the cleaning process the cleaning module according to the invention can here be placed by the user as a structural unit in its entirety next to or into the device for the production of liquid foods. Subsequently, as described, the fully automated cleaning process runs without requiring any intervention from the outside.

It is particularly advantageous for the discharge chamber to comprise an opening at the top or in the upper section of the discharge chamber, into which a supply line of the device for the production of liquid foods can be inserted.

The cleaning module according to the invention therefore has the advantage that the user must only check that sufficient amounts of a cleaning agent is present in the cleaning reservoir, and that the cleaning module must be arranged at or in the device for the production of liquid foods, and that the discharge chamber must be connected to the liquid circuit of the device for the production of liquid foods and the control connection to a respective control connector of the device for the production of liquid foods.

Subsequently the program for the cleaning runs automatically, without requiring the user to interfere in a controlling fashion. Particularly the supply of cleaning agents via the dosing device to the discharge chamber can be controlled by the device for the production of liquid foods by a control program predetermined in the device using the control connector with respect to the amount of the cleaning agent supplied to the discharge chamber and the time said cleaning agent is located in the discharge chamber.

Frequently it is necessary for devices used for the production of liquid foods in the hospitality industry that the cleaning is performed using at least two different cleaning agents. Advantageously the cleaning module according to the invention is therefore embodied such that it additionally comprises a second reservoir for a cleaning agent, which is connected to the dosing device and the discharge chamber such that the cleaning agent can be supplied via the dosage device from the second reservoir for cleaning agents into the discharge chamber. The dosing device is here embodied such that optionally cleaning agent from the first and/or the second reservoir for cleaning agents can be fed to the discharge chamber.

In this embodiment it is therefore possible to execute a cleaning process in which successively and/or simultaneously two different cleaning agents are used without requiring the intervention of the user. Rather the dosing device is controlled by a predetermined control program via the control connector in the device for the production of liquid foods such that at the desired points of time the predetermined cleaning agent or a predetermined mixture ratio of the cleaning agents is present in the discharge chamber and fed therefrom into the liquid circuit of the device for the production of liquid foods in order to achieve a desired cleaning effect.

This embodiment therefore also provides the advantage that the user only needs to check the presence of sufficient amounts of the first and second cleaning agent in the respective reservoirs for cleaning agents of the cleaning module and after connecting the cleaning module to the liquid circuit of the device for the production of liquid foods as well as the control connector of the cleaning module to a respective control connector of the device the cleaning program runs automatically so that, particularly, operating errors by the user are avoided and a correct cleaning process can be ensured, particularly a cleaning process meeting predetermined minimum standards.

Advantageously the dosing device comprises a pump and a multi-way valve, with the multi-way valve being connected to each of the reservoirs for cleaning agent and to the pump such that via the multi-way valve the pump can optionally be connected to the first or the second reservoir for cleaning agents. Thus, in this embodiment only one pump is necessary that can optionally be connected via the multi-way valve to one of the reservoirs for cleaning agents so that, using the pump, optionally cleaning agent is fed from the first or the second reservoir for cleaning agents via the multi-way valve into the discharge chamber.

Here, the multi-way valve and the pump are connected to the control connector and embodied such that via the control signals optionally a connection of the pump to the first or the second reservoir for cleaning agents can be predetermined via the control connection.

In another advantageous embodiment the dosing device comprises at least two pumps, with a first pump being connected in a liquid-feeding manner to the first reservoir for cleaning agents and to the discharge chamber and a second pump to the second reservoir for cleaning agents and the discharge chamber. Therefore, in this embodiment no multi-way valve is necessary, rather both pumps are connected to the control connector and by control signals cleaning agent can be supplied either by the pumps from the first or the second reservoir or simultaneously from both containers into the discharge chamber, dependent on the control signals transmitted via the control connector.

Advantageously, the cleaning module according to the invention is embodied such that via the control connector not only control signals are transmitted to the pumps and/or the multi-way valve but simultaneously the power supply with electricity occurs via the control connector as well. This embodiment therefore results in the advantage that the user only has to connect one connector, the control connector of the cleaning module, to the respective control connector of the device for the production of liquid foods, and this way all necessary electric connections are made.

In another advantageous embodiment the control connector and/or the power supply connection of the cleaning module is embodied as an inductive connection that can be connected in a wireless fashion. In this advantageous embodiment it is therefore only necessary for the cleaning module to be arranged at a respective position in reference to the device for the production of liquid foods and that the device, matching the inductive connector of the cleaning module, has a respective inductive connector. This way the processing step of manually connecting the control connector by the user is omitted, because the mere the correct arrangement of the cleaning module ensures an inductive connection between the cleaning module and the device for the production of liquid foods and via said inductive connection the control signals and/or the power supply of the cleaning module.

Advantageously, the cleaning module has a fresh water inlet, which is connected to the discharge chamber in a liquid-conductive manner. Here, it is particularly advantageous when the fresh water inlet is embodied as an opening in an upper side of the discharge chamber.

This is particularly advantageous when the device for the production of liquid foods has a corresponding fresh water outlet, under which the cleaning module is arranged such that fresh water can flow via the fresh water outlet into the fresh water inlet and thus into the discharge chamber of the cleaning module.

Thus, in this embodiment, in addition to the cleaning agents, fresh water can also be supplied to the discharge chamber. This results in additional advantages:

On the one hand, both the discharge chamber as well as the liquid circuit of the device for the production of liquid foods can be rinsed with fresh water flowing into the discharge chamber. This allows the removal of residual cleaning agents not only in the device for the production of liquid foods but also in the discharge chamber. Furthermore, this embodiment allows for concentrated cleaning agent to be filled into the reservoir(s) for cleaning agents, with a mixture of cleaning agent/water of a desired concentration being produced in the discharge chamber from fresh water and concentrated cleaning agent before said mixture is used to clean the liquid circuit of the device for the production of liquid foods.

The use of a concentrated cleaning agent results in the advantage that the user needs to refill the reservoir(s) for liquid agents less frequently in reference to the use of cleaning agents that cannot be diluted.

The scope of the invention also includes that the cleaning module is additionally provided with a reservoir for fresh water, which is also connected to the discharge chamber via the dosing device, so that optionally fresh water is supplied from the reservoir for fresh water of the cleaning module into the discharge chamber and is used here to be mixed with cleaning agent or for rinsing. In this embodiment no fresh water outlet is necessary in the device for the production of liquid foods.

Advantageously, reservoirs for cleaning agents as well as perhaps a reservoir for fresh water, a dosing device, and a discharge chamber are arranged in a common housing. This allows for a simple handling by the user, who can arrange the housing with all components of the cleaning module in a single movement at or in a device for the production of liquid foods. Advantageously, for this purpose the housing has a carrying handle arranged at the top so that simple handling by the user is ensured.

It is particularly advantageous for the cleaning module to be embodied as an inserted module. The cleaning module can therefore be inserted by the user into the appropriate recess at the device for the production of liquid foods, with guiding aids, such as guiding rails or appropriate walls of the insert ensuring that after the insertion of the cleaning module said module is located at the desired and correct position in reference to the device for the production of liquid foods. For this purpose, advantageously at least one handle is embodied at a front of the cleaning module for pushing in and pulling out the cleaning module in order to again allow a simple and speedy handling by the user.

The reservoir for cleaning agents and the dosing device can be embodied suitable for various cleaning agents. For example, the scope of the invention includes embodying the reservoir for cleaning agents of the cleaning module in form of a tablet container and accordingly to embody the dosing device as a tablet dosing device, which supplies a number of tables, predetermined by the control signals, from the reservoir for cleaning agents via the control connector into the discharge chamber. Additionally, an embodiment of the reservoir for cleaning agents to accept powdered cleaning agents is possible and an appropriate embodiment of the dosing device, for example a worm gear, so that an amount of powdered cleaning agent, predetermined by the control signals, can be fed to the discharge chamber.

However, tests of the applicant have shown that particularly the use of liquid cleaning agent is advantageous, because it is characterized in good dosing properties, long shelf life, and a simple refilling process by the user. Advantageously the reservoir for cleaning agent of the cleaning module according to the invention is therefore embodied suitable to accept liquid cleaning agents and for the dosing device to comprise at least one dosing pump.

Advantageously, the cleaning module is provided with at least three reservoirs for cleaning agents to accept liquid foods so that even a cleaning according to high standards of food technology can be performed fully automated by the cleaning module according to the invention using a first and a second cleaning agent, and subsequently a disinfecting agent.

The invention further relates to a device for the production of liquid foods, particularly coffee.

Such devices comprise at least one supply line and one discharge line, a supply pump, an outlet, and a control unit. The supply pump is connected to the supply line and the outlet, so that optionally liquids can be suctioned via the supply line and by the supply pump via the discharge line can be discharged at the outlet.

The control unit is embodied cooperating with the supply pump so that via control signals the operating status of the supply pump can be controlled by the control unit.

It is essential that the device according to the invention has a control connector to connect a dosing device and that the control device is embodied cooperating with the control connector and the supply pump such that, depending on the control signals of the control unit, the operating status of the supply pump and a dosing device connected to the control connector can be controlled in a cleaning mode.

The device according to the invention is therefore embodied suitable for use as an above-described cleaning module according to the invention.

The user must only connect the supply line of the device in a liquid-conducting manner to the outlet chamber of the above-described cleaning module and connect the control connector of the device to the respective control connector of the cleaning module.

The control unit advantageously comprises a cleaning program in which the cleaning process of the device for the production of liquid foods is predetermined. Depending on the cleaning program, the control unit issues respective signals to the supply pump and via the control connector to the dosing device so that in the order predetermined by the cleaning program the liquid circuit of the device is cleaned, i.e. at least the supply line, the discharge line, and the outlet of the device.

Advantageously the device comprises a multi-way valve arranged in the discharge line. The multi-way valve is provided cooperating with a control unit such that depending on the control signals of the control unit optionally the supply pump can be connected in a liquid-conductive manner by the multi-way valve via the discharge line to the outlet or via the rinsing line to at least one other component of the device.

Therefore, the flow path can optionally be predetermined via the multi-way valve, beginning at the supply line between the discharge line and at least one additional component of the device. Due to the fact that the multi-way valve of the device is also connected to the control unit an arbitrary period of time, type of cleaning agent, and/or amount of cleaning agent can be predetermined in the cleaning program for the leaning process of the discharge line, on the one hand, and the other components of the device, on the other hand. Therefore, a fully automated cleaning of several flow paths of the device and/or several components of the device can be predetermined by the cleaning program of the control device, having different parameters, such as duration, amount of cleaning agent, and/or concentration of cleaning agent.

This way, a correct, fully automated cleaning if possible, if necessary utilizing a complex cleaning process, and operating errors by the user are excluded.

Typical applications are devices for the production of coffee. Such devices typically comprise a brewing unit for the production of coffee. Advantageously the device according to the invention is embodied as such a device for the production of coffee and further comprises a brewing unit-rinsing line as well as the above-described multi-way valve. The multi-way valve is connected to the brewing unit-rinsing line and the discharge line as well as a supply pump so that optionally the supply pump can be connected in a liquid-conductive manner either via the multi-way valve to the brewing unit-rinsing line or via the multi-way valve to the discharge line.

Advantageously the device according to the invention has an instant mixer, which can be connected via the instant mixer-rinsing line to the above-described multi-way valve. Here, the multi-way valve is embodied such that the supply pump can optionally be connected to the discharge line or the brewing unit-rinsing line or the instant mixer-rinsing line, depending on the control signals of the control unit.

The scope of the invention includes connecting other and/or additional components of the device for the production of liquid foods via respective rinsing lines to the respectively embodied multi-way valve so that by the control unit optionally each component can be rinsed, in particular, with different cleaning processes being predetermined for each component, particularly different cleaning agents, durations of the cleaning process, and/or concentrations of the cleaning agent.

The invention further relates to a device for the production of liquid foods, particularly coffee. Such a device according to the invention comprises the above-described components supply line, discharge line, supply pump, outlet, and a control unit in the above-described embodiment. It is essential for the device to include a fresh water supply line with a fresh water cut-off valve. The fresh water supply line opens at a fresh water outlet, which can be connected in a liquid-conducting manner to a discharge chamber of a cleaning module, as above described. The fresh water cut-off valve is embodied cooperating with the control unit such that the fresh water supply can be connected and disconnected depending on the control signals of the control unit.

This device according to the invention allows therefore the automatic filling of a container, arranged below the fresh water outlet, with fresh water and the supply of liquid from the reservoir via the supply line to clean and rinse the device. In this embodiment it is therefore possible that a conventional reservoir with cleaning agent or concentrated cleaning agent is placed underneath the fresh water outlet and subsequently the cleaning agent is fed by the supply pump via the supply line in an automated cleaning cycle, controlled by the control unit, to clean the device.

The use of concentrated cleaning agent is advantageous when the control unit is embodied such that first the concentrated cleaning agent is diluted in the reservoir by adding fresh water via the fresh water outlet to form a predetermined concentration and subsequently the mixture of cleaning agent is used to clean the device. It is particularly advantageous for the control unit to be embodied such that first the cleaning agent or the mixture of cleaning agents is completely removed from the reservoir and subsequently fresh water is filled into the reservoir via the fresh water outlet so that in another step by the supply pump the device is rinsed with fresh water via the supply line and potential residue of cleaning agent is removed. Based on the addition of fresh water that can be controlled by a control unit an automated rinsing process of the device is possible without requiring any cleaning module according to the invention.

It is particularly advantageous to embody the above-described device at least according to one of claims 13 through 16, so that both the advantage of the controlled supply of fresh water as well as the advantage of using a control module according to the invention is given.

In this case, not only the supply and supply amount of the cleaning agent can be predetermined by the control unit in a cleaning program but also the mixture ratios of fresh water and cleaning agent in a discharge chamber of the cleaning agent, using a respective control of the fresh water cut-off valve and the amount and duration of the rinsing process with fresh water.

Typically, devices for the production of liquid foods, particularly coffee makers, are provided with a refrigerated chamber, which is embodied suitable for the acceptance of containers with liquid foods or food additives. For example, in coffee makers, milk containers are stored in such refrigerated chambers. The supply line of the device opens in the refrigerated chamber so that the supply line in the refrigerated chamber can be inserted into a milk container and thus milk can be supplied by the supply pump from the refrigerated chamber via the supply line.

Advantageously the device comprises at least one cleaning module according to the invention as above-described and the cleaning module and the refrigerated chamber according to the device are embodied such that the cleaning module can be inserted into the module chamber.

In an advantageous embodiment, for cleaning the user must only remove the reservoir, such as the milk container, and instead of the milk container insert the cleaning module into the refrigerated chamber and appropriately insert the supply line into the discharge chamber of the cleaning module.

In an advantageous embodiment this device additionally comprises a fresh water supply line as above described, which opens in the refrigerated chamber. The fresh water inlet of the cleaning module and the opening of the fresh water supply line are embodied such that the opening of the fresh water supply line is located above the fresh water inlet of the cleaning module when the cleaning module is inserted into the refrigerated chamber.

Here, it is particularly advantageous when for a precise positioning the refrigerated chamber is provided with guidance rails for the cleaning module and/or the cleaning module has approximately the interior dimensions of the refrigerated chamber with regard to width and length, so that when the cleaning module is inserted automatically a predetermined positioning occurs in reference to the refrigerated chamber.

The device according to the invention particularly comprises devices for the production of coffee. Additionally, the scope of the invention includes to suitably embody the device for the production of other liquid foods, particularly by mixing a concentrate, such as for example an instant powder, with a liquid.

The invention further relates to a method for cleaning a device for the production of liquid foods, particularly coffee, comprising the following steps:
In a step A a cleaning agent is fed by a dosing device from a reservoir for cleaning agent to a discharge chamber.
In a step B the cleaning agent is fed by the supply pump from the discharge chamber and guided through a discharge line and an outlet of the device so that they can be cleaned via said cleaning agent.
In a step C fresh water is supplied to the discharge chamber and in a step D the fresh water is supplied by the supply pump from the discharge chamber and guided through the discharge line and the outlet of the device so that they are rinsed with the fresh water.

It is essential that the supply of cleaning agent and fresh water to the discharge chamber occurs automatically such that these processing steps are controlled via the control device of the device.

In the method according to the invention, advantageously in step A fresh water is additionally supplied to the discharge chamber so that a mixture of cleaning agent and fresh water develops in the discharge chamber. The mixture ratio is here predetermined by the control unit, which appropriately controls the dosing device and a cut-off valve in the fresh water supply line. Furthermore, in step B instead of the cleaning agent the mixture of fresh water and cleaning agent of the discharge chamber, prepared as described above, is used to clean the device.

Furthermore it is advantageous in the method according to the invention if the following steps are performed between step B and step C:
In a step B.1 a second cleaning agent is supplied from a second reservoir for cleaning agents by the dosing device into the discharge chamber and in a step B.2 the second cleaning agent is supplied by the supply pump from the discharge chamber, and guided through the discharge line and the outlet of the device so that they are cleaned in step B.2 with the second cleaning agent.

It is particularly advantageous for fresh water to be additionally supplied to the discharge chamber in step B.1 so that a mixture of the second cleaning agent and fresh water is given in the discharge chamber, with the mixture ratio being predetermined by the control unit, and that in step B.2, instead of cleaning agent, the above-described mixture of fresh water and the second cleaning agent is used to clean the device.

Furthermore, it is advantageous for the entire cleaning process to be executed several times, either partially or in its entirety, with in one run, as described above, the discharge line and the outlet of the device being cleaned and rinsed and in another run the supply pump being connected to another component, such as a brewing unit of the device, so that in this additional run the brewing unit is cleaned and rinsed. It is particularly advantageous when in an additional further run the supply pump is connected to other components of the device, such as an instant mixer for example, so that this additional component is also cleaned and rinsed.

Advantageously the entire above-described cleaning process is performed automatically, controlled by a control unit.

### BRIEF DESCRIPTION OF THE DRAWINGS

Additional advantageous embodiments of the invention are described in the following using an exemplary embodiment. Shown is:

FIG. 1 is a flow-chart illustration of an exemplary embodiment of a device according to the invention for the production of liquid foods, embodied as a coffee maker, with an insertion module according to the invention, in a flow chart illustration.

### DETAILED DESCRIPTION OF THE PREFERRED EMBODIMENTS

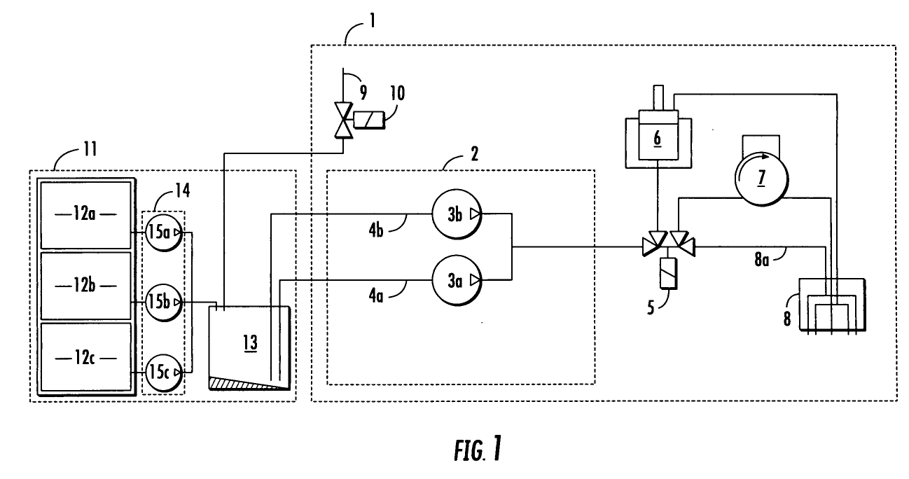

The device for the production of liquid foods according to the invention, shown in FIG. 1 embodied as a coffee maker, comprises a refrigerated unit 2 with supply pumps 3 (first supply pump 3a and second supply pump 3b.) At their suction side, the supply pumps 3 are each connected to supply lines 4 (first supply line 4a and second supply line 4b.)

The coffee maker further comprises a multi-way valve 5, a brewing unit 6, an instant mixer 7, an outlet 8, and a fresh water supply line 9 with a fresh water cut-off valve 10.

The coffee maker according to the invention further comprises a cleaning module embodied as an inserting module 11, which in turn comprises three reservoirs 12 for cleaning agents (first reservoir 12a for cleaning agents, second reservoir 12b for cleaning agents, and third reservoir 12c for cleaning agents) as well as a discharge chamber 13 and a dosing device 14. The dosing device 14 in turn comprises three dosing pumps 15 (a first dosing pump 15a, a second dosing pump 15b, and a third dosing pump 15c.)

The coffee maker 1 further comprises a control unit, not shown, which sends control signals to control the supply pumps 3, the multi-way valve 5, and the fresh water cut-off valve 10.

Furthermore, the control unit is connected to a control connector of the coffee maker, now shown, and the insertion module is also provided with a control connector that the user can connect to the control connector of the coffee maker. When both control connectors are connected, the control device is further connected to the dosing pumps 15a, 15b, and 15c and controls them via control signals. In addition to control signals the dosing pumps 15 are also provided with electric power by the control connectors.

Furthermore, the reservoirs 12 for cleaning agents are each provided with fill level sensors, also connected via the control connectors to the control unit. The fill level sensors each provide measurement signals to the control unit and from these measurement signals the control unit determines the fill level of the cleaning agent for each of the reservoirs 12a, 12b, and 12c for cleaning agents.

In standard operation, the insertion module is not connected to the coffee maker, instead two food containers are located in a refrigerated chamber of a refrigeration unit 2, each of which is connected to one of the supply lines 4a and 4b. Typically, these food containers are milk containers so that by the supply pumps 3a and 3b milk can be supplied to the outlet 8 via multi-way valves 5 and thus, in addition to the coffee created by the brewing unit 6, milk can be discharged at the outlet.

Therefore the refrigerated unit has two supply lines 4 and two supply pumps 3 so that optionally different types of milk can be discharged via the outlet, for example whole milk and reduced fat milk.

In order to clean the coffee maker 1 the user removes the food reservoir from the refrigerated chamber of the refrigerated unit 2 and instead thereof pushes the insertion module 11 into the refrigerated chamber of the refrigerated unit 2. All components 12 through 15 of the insertion module 11 are arranged in a housing, provided with a handle at the top and the front of the housing. The user can therefore insert the insertion module into the refrigerated chamber of the refrigerated unit in a simple fashion.

The discharge chamber 13 of the insertion module 11 has an opening at the top. The user inserts the supply lines 4a and 4b, which open in the refrigerated chamber of the refrigerated unit, into this opening such that the supply lines open approximately at the bottom of the discharge chamber 13.

As described above, the insertion module 11 has three reservoirs for cleaning agents, with a first liquid cleaning agent being filled into the reservoir 12a for cleaning agents, a second liquid cleaning agent into the reservoir 12b for cleaning agents, and a liquid disinfectant into the reservoir 12c for cleaning agents, each in a concentrated form.

After the insertion of the insertion module 11 into the refrigerated chamber of the refrigerated unit 2 and the insertion of the supply lines 4a and 4b into the discharge chamber 13 the user also connects the control connector of the insertion module to the control connector of the coffee maker so that the control device of the coffee maker is connected to the above-described components of the insertion module.

Finally, using an input unit, not shown, the user starts the cleaning program stored in the control unit which now fully automatically determines the cleaning process of the coffee maker.

First, it is tested via the fill level sensors if sufficient amounts of cleaning agents are present in each of the reservoirs 12 for cleaning agents for the entire cleaning program. If that is not the case, an optic and/or acoustic warning signal is displayed to the user via a display, not shown.

In case of sufficient fill levels in each of the reservoirs for cleaning agents, first a predetermined amount of the first cleaning agent is fed to the discharge chamber 13 via the dosing pump 15a. The discharge chamber 13 has a fresh water inlet at the top. The fresh water supply line 9 of the coffee maker opens in the refrigerated chamber of the refrigerated unit and the opening is arranged such that it is above the fresh water inlet of the insertion module 11 when the insertion module 11 is inserted.

After the first cleaning agent has been fed to the discharge chamber in a predetermined amount, the respective control of the fresh water cut-off valve 10 feeds fresh water into the discharge chamber in a predetermined amount so that a mixture of fresh water and the cleaning agent 1 is provided in a predetermined concentration of the cleaning agent 1 in the discharge chamber 13.

Subsequently, by the supply pumps 3a and 3b, simultaneously the mixture of cleaning agents is fed via the supply lines 4b and 4a to the multi-way valve 5. The multi-way valve 5 is switched such that first a supply line 8a and the outlet 8 are flown through and cleaned appropriately. Here, of course the supply lines 4a and 4b as well as the connection lines between the supply pump 3a and 3b and the multi-way valve 5 are cleaned as well.

Subsequently, the disinfectant is supplied by the dosing pump 15c from the reservoir 12c for cleaning agents to the discharge chamber 13 and therefrom pumped by the supply pumps 3a and 3b via the supply lines 4a and 4b as well as the discharge line 8a to the outlet 8, so that disinfection is also performed after cleaning.

Subsequently fresh water is fed via the fresh water supply lines 9 to the discharge chamber 13 and this is also pumped to the outlet 8, so that a rinsing process occurs and residual cleaning agents or residual disinfectants are removed in the rinsing process.

After the conclusion of this first cleaning cycle the cleaning cycle is performed once more, however here the multi-way valve 5 is switched such that the supply pumps 3a and 3b are now connected to the outlet 8 via the brewing unit 6 and no longer via the discharge line 8a.

In this second cleaning cycle cleaning occurs as described above, however this time instead of the first cleaning agent from the reservoir 12a for cleaning agents the second cleaning agent from the reservoir 12b for cleaning agents is used. This second cleaning agent is particularly suitable for cleaning the brewing unit. The other steps of cleaning occur as (described) above, with the difference that the second cleaning agent is supplied by the second dosing pump 15b to the discharge unit 13.

In a third cleaning cycle the multi-way valve 5 is finally switched such that the supply pumps 3a and 3b are connected to the outlet via the instant mixer 7 and the instant cleaner is cleaned accordingly, with this cleaning process also being performed with the second cleaning agent from the second reservoir 12b for cleaning agents.

The entire cleaning (process) proceeds fully automatically according to the cleaning program predetermined in the control unit without any interference by a user being necessary.

The present invention therefore allows for the first time to fully automatically clean a coffee maker and particularly different components thereof by using different conditions, such as different cleaning agents and/or concentrations of cleaning agents in a fully-automated fashion.

1. A cleaning module for machines for production of liquid foods, comprising at least one reservoir for cleaning agents (12a, 12b, 12c) to accept cleaning agents, at least one dosing device (14) with a control connector, and at least one discharge chamber (13), with the dosing device (14) being connected to the cleaning reservoir (12a, 12b, 12c) and the discharge chamber (13) such that the cleaning agent can be fed from the reservoir for cleaning agents via the dosing device (14) into the discharge chamber (13).

2. A cleaning device according to claim 1, wherein the reservoir for cleaning agents (12a, 12b, 12c), the dosing device (14), and the discharge chamber (13) are combined into a structural unit.

3. A cleaning module according to claim 1, wherein the cleaning module further comprises at least a second reservoir for cleaning agents (12b) which is connected to the dosing device (14) and the discharge chamber (13) such that cleaning agents can be fed by the dosing device (14) from the second reservoir for cleaning agents (12b) into the discharge chamber (13) and the dosing device (14) is embodied such that cleaning agent can be fed from one or the other of the first and the second reservoir for cleaning agents (12a, 12b) into the discharge chamber (13).

4. A cleaning module according to claim 3, wherein the dosing device comprises a dosing pump and a multi-way valve, with the multi-way valve being connected to each of the reservoirs for cleaning agents and the dosing pump such that the dosing pump can optionally be connected to the first or to the second reservoir for cleaning agents via the multi-way valve.

5. A cleaning module according to claim 3, wherein the dosing device (14) comprises at least first and second dosing pumps (15a, 15b), with the first dosing pump (15a) being connected to the first reservoir for cleaning agents (12a) and to the discharge chamber (13) and the second dosing pump (15b) being connected to the second reservoir for the second cleaning agent (12b) and the discharge chamber (13) in a liquid-conducting manner.

6. A cleaning module according to claim 4, wherein the dosing device (14) is provided with an electric control and power supply connector, which is connected in an electrically conducting fashion to the at least one dosing pump (12a, 12b, 12c) and/or a multi-way valve of the dosing device (14).

7. A cleaning module according to claim 6, wherein at least one of the control connection or the power supply connector comprise inductive connectors that can be connected in a wireless fashion.

8. A cleaning module according to claim 1, wherein the cleaning module has a fresh water supply, which is connected in a conductive fashion to the discharge chamber (13), and the fresh water supply is provided at an opening at a top of the discharge chamber (13).

9. A cleaning module according to claim 1, wherein the discharge chamber (13) has an opening for inserting a supply line (4a, 4b), and the opening is provided at a top of the discharge chamber (13).

10. A cleaning module according to claim 1, wherein the reservoirs for cleaning agents (12a, 12b, 12c), the dosing device (14), and the discharge chamber (13) are arranged in a common housing, and the housing is provided with a handle arranged at a top thereof.

11. A cleaning module according to claim 10, wherein the cleaning module is provided as an insertion module (11), and at least one handle is provided at the front of the cleaning module for pushing in and pulling out the cleaning module.

12. A cleaning module according to claim 1, wherein the reservoirs for cleaning agents (12a, 12b, 12c) is embodied to accept liquid cleaning agents, and the cleaning module has three of the reservoirs for cleaning agents (12a, 12b, 12c) to accept liquid cleaning agents, each of which is connected to the discharge chamber (13) via the dosing device (14).

13. A device for producing liquid foods, comprising at least one supply line (4a, 4b) and a discharge line (8a), a supply pump (3a, 3b), an outlet (8), and a control unit, with the supply pump (3a, 3b) being connected to the supply line (4a, 4b) and the outlet (8) such that liquids can be suctioned via the supply line to the supply pump and can be supplied by the supply pump via the discharge line (8a) to the outlet (8), with the control unit being embodied cooperating with the supply pump (3a, 3b) such that the control unit controls the operating state of the supply pump via control signals, the device is provided with a control connector to connect a dosing device (14) and the control device is embodied cooperating with the control connector and the supply pump (3a, 3b) in such a manner that the operating conditions of the supply pump and a dosing device (14) connected to the control connector can be controlled in the cleaning mode depending on the control signals of the control unit.

14. A device according to claim 13, further comprising a multi-way valve (5), arranged in the discharge line (8a), with the multi-way valve (5) being embodied cooperating with the control unit such that depending on the control signals of the control unit optionally the supply pump (3) can be connected in a liquid-conductive manner via the discharge line (8a) to the outlet (8) or via a rinsing line to at least one additional component of the device.

15. A device according to claim 14, further comprising a brewing unit (6) to produce coffee and a brewing unit-rinsing line, with the multi-way valve (5) being embodied such that depending on the control signals of the control unit optionally the supply pump (3a, 3b) can be connected in a liquid-conductive manner by the multi-way valve (5) via the brewing unit-rinsing line to the brewing unit (6).

16. A device according to claim 13, further comprising an instant mixer (7) and an instant mixer-rinsing line, with the multi-way valve (5) being embodied such that depending on control signals of the control unit optionally the supply pump (3a, 3b) can be connected in a liquid-conductive manner by the multi-way valve via the instant mixer-rinsing line to the instant mixer (7).

17. A device according to claim 13, further comprising a fresh water supply line (9) with a fresh water cut-off valve (10), with the fresh water supply line (9) opening in a fresh water outlet, which can be connected to a discharge chamber (13) of a cleaning module, and with the fresh water cut-off valve (10) being embodied cooperating with the control unit such that depending on control signals of the control unit, the fresh water supply can be switched on and off.

18. A device according to claim 17, further comprising a refrigerated chamber to accept containers with liquid foods or food additives, with the supply line (4a, 4b) opening in the refrigerated chamber so that liquids can be supplied by the supply pump (3a, 3b) from the refrigerated chamber via the supply line and that the device comprises a cleaning module having at least one reservoir for cleaning agents (12a, 12b, 12c) to accept cleaning agents, at least one dosing device (14) with a control connector, and at least one discharge chamber (13), with the dosing device (14) being connected to the cleaning reservoir (12a, 12b, 12c) and the discharge chamber (13) such that the cleaning agent can be fed from the reservoir for cleaning agents via the dosing device (14) into the discharge chamber (13), with the cleaning module and the refrigerated chamber being embodied such that the cleaning module can be inserted into the refrigerated chamber.

19. A device according to claim 18, wherein the fresh water supply line (9) opens in the refrigerated chamber and the fresh water inlet of the cleaning module and the fresh water supply line (9) opening are arranged such that when the cleaning module is inserted into the refrigerated chamber the opening of the fresh water supply line (9) is located above the fresh water inlet of the cleaning module.

20. A method for cleaning a device for the production of liquid foods, comprising the following steps:
A supplying cleaning agents from a reservoir for cleaning agents via the dosing device (14) to a discharge chamber (13),
B supplying the cleaning agent from the discharge chamber (13) via a supply pump (3) and cleaning a discharge line (8a) and an outlet of the device with the cleaning agent,
C supplying fresh water to the discharge chamber (13),
D feeding fresh water from the discharge chamber (13) by the supply pump (3) and rinsing the discharge line (8a) and the outlet of the device with said fresh water,
with the supply of cleaning agents and fresh water occurring automatically in the discharge chamber (13) and being controlled via a control device of the device.

21. A method according to claim 20, wherein in step A additionally fresh water is fed to the discharge chamber (24) so that in the discharge chamber (13) a mixture of cleaning agent and fresh water is provided, with the mixture ratio being predetermined by the control unit, and that in step B the cleaning agent is supplied along with a mixture of fresh water for cleaning.

22. A method according to claim 21, wherein between step B and step C the following steps are performed:
B.1 feeding a second cleaning agent from a second reservoir for cleaning agents by the dosing device (14) to the discharge chamber (13), and
B.2 feeding a second cleaning agent from the discharge chamber (13) by the supply pump (3) and cleaning the discharge line (8a) and the outlet of the device with the second cleaning agent,
and in step B.1 additional fresh water is supplied to the discharge chamber (13) such that in the discharge chamber (13) a mixture of two cleaning agents and fresh water is provided, with the mixture ratio being predetermined by the control unit and in step B.2 instead of the second cleaning agent the mixture of fresh water and the second cleaning agent is used for cleaning.

23. A method according to claim 22, wherein the entire cleaning method is executed several times, with in one run the discharge line (8a) and the outlet (18) of the device being cleaned and rinsed and in another run the supply pump is connected to the brewing unit (6) of the device so that the brewing unit (6) is cleaned and rinsed, and in another run the supply pump (3) is connected to an instant mixer (7) of the device so that the instant mixer (7) is cleaned and rinsed.

24. A method according to claim 20, wherein the entire process of the cleaning method runs automatically controlled by a control unit.
